(19) United States
(12) Patent Application Publication
(10) Pub. No.: US 2007/0203632 A1
(43) Pub. Date: Aug. 30, 2007

(54) Oscillation control apparatus for vehicle and method for controlling oscillation

(75) Inventor: Souichi Saitou, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/705,603

(22) Filed: Feb. 13, 2007

(30) Foreign Application Priority Data
Feb. 15, 2006 (JP) 2006-037957

(51) Int. Cl. G06F 17/00

(52) U.S. Cl. 701/51

(57) ABSTRACT

An oscillation control apparatus is applied to a vehicle having a drive train for traveling on a road surface. The drive train includes a power source for generating torque transmitted to wheels via a shaft. The oscillation control apparatus includes a perfect reference model of the drive train. The perfect reference model inputs the torque, which is generated suing the power source, and road load, which is resistance force applied to the vehicle. The perfect reference model outputs revolution speed of the power source. The perfect reference model includes a perfect reference-speed calculating unit for calculating perfect reference speed of the power source under an assumption that the shaft is free from torsion therein. The perfect reference model further includes a power controlling unit for controlling the torque on the basis of the perfect reference speed.

### CROSS REFERENCE TO RELATED APPLICATIONS

This application is based on and incorporates herein by reference Japanese Patent Application No. 2006-37957 filed on Feb. 15, 2006.

### FIELD OF THE INVENTION

The present invention relates to an oscillation control apparatus for a vehicle. The present invention further relates to method for controlling oscillation of a vehicle.

### BACKGROUND OF THE INVENTION

When a driver manipulates an accelerator pedal of a vehicle, torque of a drive shaft may fluctuate, and consequently, oscillation may occur in the vehicle.

For example, according to Japanese Patent 2574920, a transfer function between an accelerator position input and a throttle position output is defined on the basis of an actual transfer function and a desired transfer function. The actual transfer function is defined between a throttle position input and a drive shaft torque output as is intrinsic to an actual vehicle. The desired transfer function is defined between the accelerator position input and drive shaft torque of a target vehicle. In this structure, a pre-compensator is provided for performing a throttle position control. The pre-compensator satisfies the defined transfer function to reduce oscillation of the vehicle. A performance of reduction in oscillation depends on accuracy of the transfer function. In this JP '920, when a discrepancy arises between the desired transfer function and the actual transfer function due to an components tolerance, aged deterioration, and the like, an accuracy of the throttle position control may be degraded.

On the other hand, in JP-A-6-257480, an additional unit is provided for directly measuring the torsion angle of the drive shaft. Engine torque is controlled on the basis of the torsion angle, so as to reduce oscillation in the vehicle. In this structure, oscillation can be reduced regardless of an components tolerance or aged deterioration, dissimilarly to JP '920. However, in this structure, additional devices are needed for measuring the torsion angle. Accordingly, the structure may be complicated, and cost for the system may become high.

### SUMMARY OF THE INVENTION

The present invention addresses the above disadvantage. According to one aspect of the present invention, an oscillation control apparatus for a vehicle having a drive train for traveling on a road surface, the drive train including a power source for generating torque transmitted to wheels via a shaft, the oscillation control apparatus including a perfect reference model of the drive train. The perfect reference model inputs the torque, which is generated using the power source, and road load, which is resistance force applied to the vehicle. The perfect reference model outputs perfect reference speed of the power source. The perfect reference model includes a perfect reference-speed calculating unit for calculating perfect reference speed of the power source under an assumption that the shaft is free from torsion therein. A power controlling unit controls the torque on the basis of the perfect reference speed.

According to another aspect of the present invention, a method for controlling oscillation of a vehicle having a drive train for traveling on a road surface, the drive train including a power source for generating torque transmitted to wheels via a shaft, the method includes calculating perfect reference speed of the power source on the basis of the torque, which is generated using the power source, and road load, which is resistance force applied to the vehicle, under an assumption that the shaft is free from torsion therein. The method further includes controlling revolution speed of the power source to generate the torque on the basis of the perfect reference speed.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a vehicle including a drive train;

FIG. 2A is a schematic view showing an actual model of the drive train, and FIG. 2B is a schematic view showing a perfect reference model of the drive train;

FIG. 3 is a block diagram showing an oscillation control apparatus for the vehicle;

FIG. 4 is a block diagram showing a perfect reference-speed calculating unit of the oscillation control apparatus;

FIG. 5 is a block diagram showing an example of a model-error-cancellation calculating portion of the perfect reference-speed calculating unit;

FIG. 6 is a block diagram showing an oscillation control torque calculating unit of the oscillation control apparatus;

FIG. 7 is a flowchart showing a processing of the oscillation control apparatus;

FIG. 8 is a flowchart showing a processing of the perfect reference-speed calculating unit;

FIG. 9 is a flowchart showing a processing of the torque-correction calculating unit; and

FIG. 10A is a graph showing a transition of the input shaft torque, and FIG. 10B is a graph showing a transition of the engine speed.

### DETAILED DESCRIPTION OF PREFERRED EMBODIMENTS

### First Embodiment

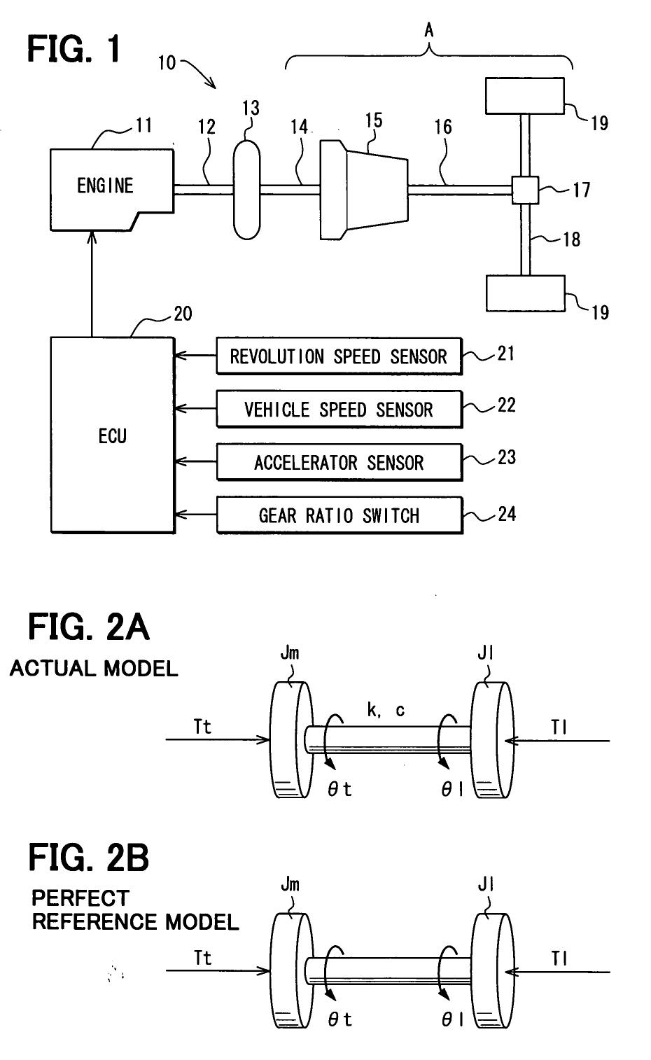

As shown in FIG. 1, a vehicle 10 includes an internal combustion engine 11 such as a gasoline engine as a power source. The engine 11 is a spark ignition engine having a spark-ignition structure. A torque converter 13 connects with a crankshaft 12 of the engine 11. A gear train 15 connects with the torque converter 13 via a gear input shaft 14. Right and left wheels 19 connect with a propeller shaft 16 via a differential gear 17 and a drive shaft 18. The propeller shaft 16 is connected as an output shaft of the gear train 15. As the engine 11 operates, the crankshaft 12 rotates, so that the rotation of the crankshaft 12 is transferred to the wheels 19 via the torque converter 13, a gear input shaft 14, the gear train 15, the propeller shaft 16, the differential gear 17, and the drive shaft 18. Thus, the wheels 19 rotate, so that the vehicle 10 travels.

An electronic control unit (ECU) 20 includes a well-known microcomputer that is constructed of a CPU, a ROM, a RAM, an EEPROM, and the like. Various sensors and switches output detection signals sequentially to the ECU 20. The various sensors and switches include a revolution speed sensor 21, a vehicle speed sensor 22, an accelerator sensor 23, a gear ratio switch 24, and the like. The revolution speed sensor 21 detects the crankshaft revolution speed (engine speed) of the engine 11. The vehicle speed sensor 22 detects the speed of the vehicle 10 (vehicle speed). The accelerator sensor 23 detects the accelerator position manipulated by a driver of the vehicle 10. The gear ratio switch 24 outputs the gear ratio signal, which indicates the gear ratio of the gear train 15.

The ECU 20 optimally controls the air quantity and ignition timing of the engine 11 on the basis of a driver's request torque and the running state of the engine 11 such as the engine revolution speed (engine speed) and engine load, on each occasion as are calculated in accordance with the accelerator position and the like. Thus, the request torque of the driver is attained.

In general, multiple ECUs are provided to an actual vehicle. The ECUs interconnect with each other thereby being communicable via a communication unit such as a CAN. The detection signals of the sensors and switches do not necessarily connect with an identical ECU, but each of the signals of the sensor and the switch is output to one associated ECU, and is transmitted to another ECU via the CAN.

In this embodiment, it is aimed to reduce oscillation of the vehicle 10, which arises during an acceleration or deceleration complying with the request of the driver. The oscillation reduction (oscillation control) will now be described.

During the accelerating or decelerating of the vehicle 10, the engine speed fluctuates due to torsion of the drive shaft 18 and the like. As a result, the oscillation (persistent oscillation) arises in the vehicle 10 in consequence of the fluctuation. As shown in FIG. 2A, a drive train model of the vehicle 10 includes a vehicular components A in FIG. 1 from the gear train 15 to the wheels 19. Referring to FIG. 2A, Jm denotes the inertia of the engine 11 and the surrounding power components including a flywheel, the crankshaft 12, the torque converter 13, and the gear input shaft 14. JI denotes the inertia of drive train components including the gear train 15, the propeller shaft 16, the differential gear 17, the drive shaft 18, and the wheels 19. Tt denotes input shaft torque, TI a road load, θt an gear input shaft revolution speed, and θI an propeller shaft revolution speed. The input shaft torque Tt is indicated by a torque, which is calculated by multiplying crankshaft torque by torque converter gain.

In the model depicted in FIG. 2A, the torsion is generated in the drive shaft 18 and the like, corresponding to the torsional rigidity k of the drive shaft 18 and the like, viscous resistance c, and backlash caused in the gears. Input shaft revolution speed θt and output shaft revolution speed θI cause a difference therebetween because of the torsion. Consequently, oscillation arises in the vehicle 10.

Therefore, as shown in FIG. 2B, a perfect reference model is created for an oscillation reduction control (oscillation control) of the vehicle. This perfect reference model is created under an assumption that the shaft doesn't twist, and a torque correction is performed in accordance with the deviation between the actual engine speed and a perfect reference speed calculated using the perfect reference model. That is, in this assumption, the drive shaft 18 is free from torsion therein. The perfect reference model can be defined irrespective of an components tolerance, aged deterioration, and the like because of the assumption that the torsion is not generated in the drive shaft 18 and the like. Likewise to the actual vehicle model shown in FIG. 2A, the perfect reference model inputs both the input shaft torque Tt and the road load TI, and outputs the engine speed (perfect reference speed). It is assumed that the torsional rigidity k, the viscous resistance c of the drive shaft 18, and the like do not exist in this perfect reference model.

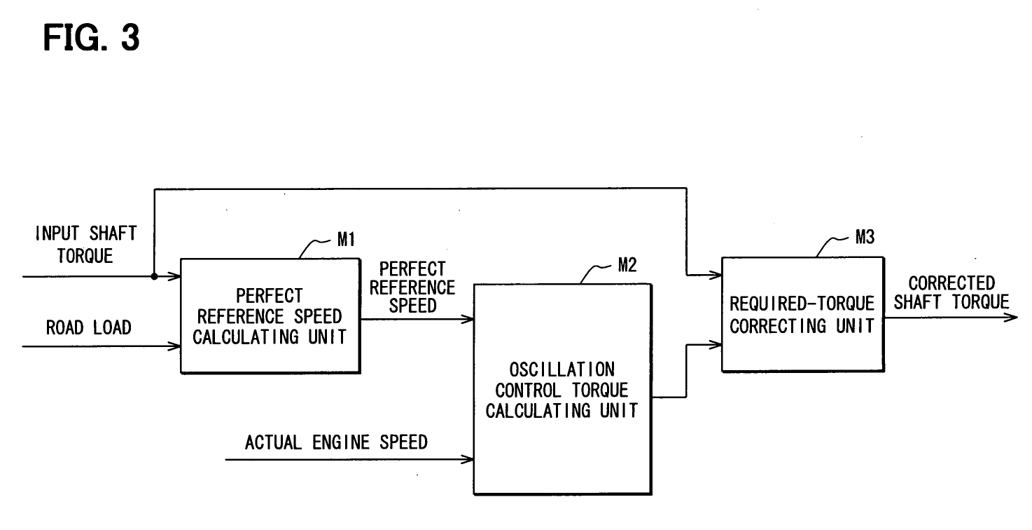

Referring to FIG. 3, a perfect reference-speed calculating unit M1 calculates the perfect reference speed using the perfect reference model on the basis of the input shaft torque and the road load, which are model inputs. An oscillation control torque calculating unit M2 calculates an oscillation control torque on the basis of the deviation between the perfect reference speed and the actual engine speed. A required-torque correcting unit M3 corrects the input shaft torque using the oscillation control torque, thereby calculating a corrected shaft torque. In this embodiment, the corrected shaft torque is calculated by subtracting the oscillation control torque from the input shaft torque (corrected shaft torque=input shaft torque−oscillation control torque).

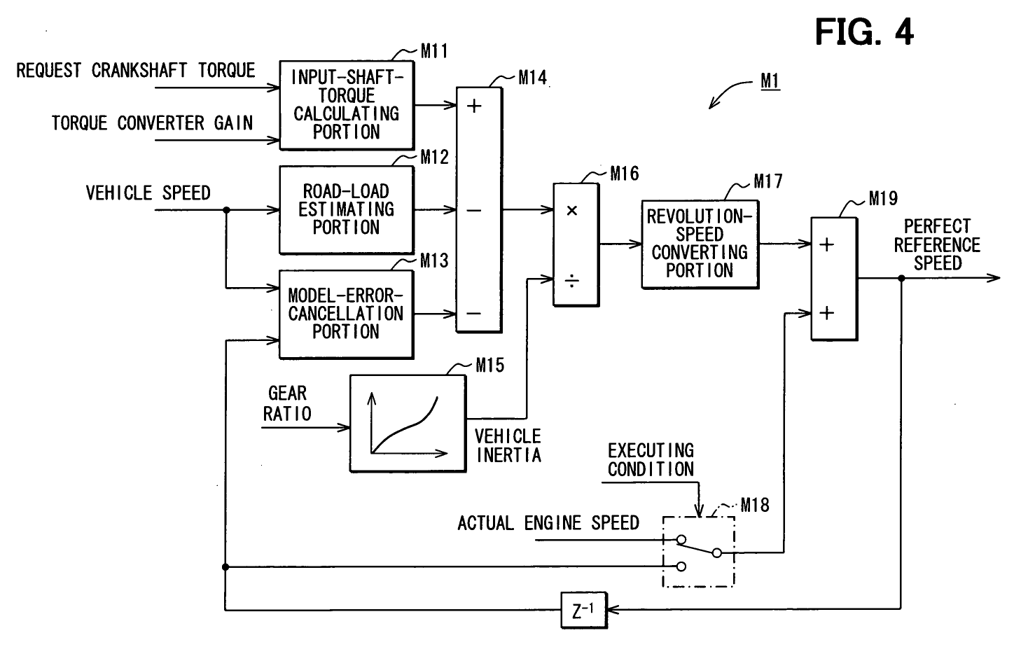

Next, the detailed configuration of the perfect reference-speed calculating unit M1 is described with reference to FIG. 4.

An input-shaft-torque calculating portion M11 calculates the input shaft torque [Nm] by multiplying the torque converter gain of the torque converter 13 by the request crankshaft torque. The request crankshaft torque is calculated on the basis of both the engine speed and the accelerator position manipulated by the driver. A road-load estimating portion M12 estimates the road load [Nm] using a quadratic formula of the vehicle speed, on the basis of the vehicle speed on each occasion. A model-error-cancellation portion M13 calculates a model-error-cancellation amount [Nm] on the basis of the vehicle speed (actual vehicle speed) and the previous value of the perfect reference speed as main parameters.

The model-error-cancellation portion M13 evaluates a gear-input-shaft revolution speed (gear-input-shaft speed) on the basis of the vehicle speed, the gear ratio, and the radius (tyre radius) of a tyre. This model-error-cancellation portion M13 finely adjusts the perfect reference model on the basis of the comparison between the gear-input-shaft speed and the previous value of the perfect reference speed.

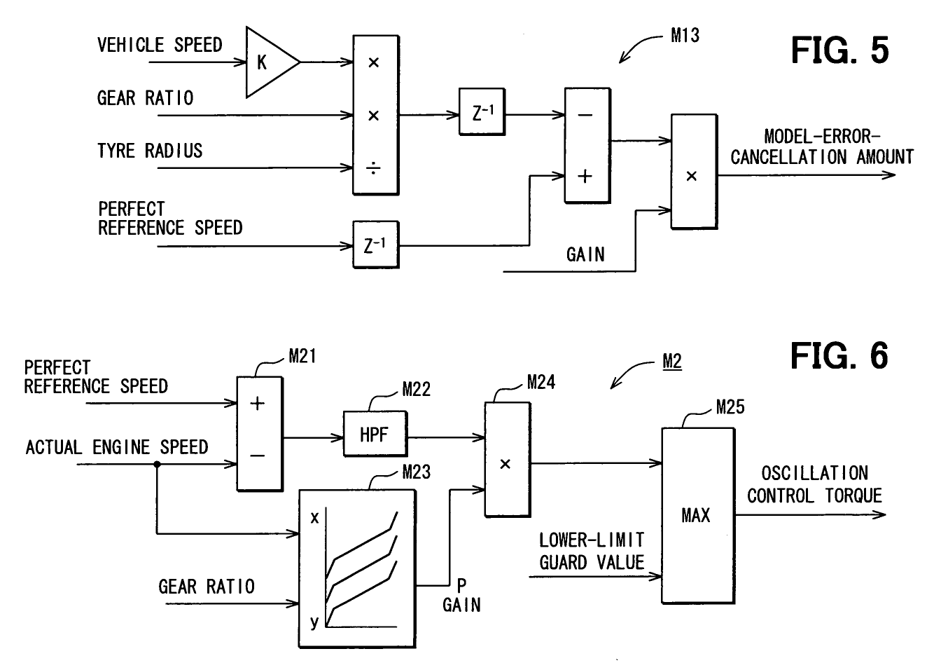

As shown in FIG. 5, by way of example, the model-error-cancellation portion M13 calculates the model-error-cancellation amount on the basis of the vehicle speed, the gear ratio, the tyre radius, the perfect reference speed, a gain, and the contains a unit conversion coefficient. By way of example, the calculation formula of the model-error-cancellation amount is represented by the Formula (1) below.

Model-error-cancellation amount={Perfect reference speed−(Vehicle speed×Unit conversion coefficient×Gear ratio/Tyre radius)}×Gain (1)

Acceleration of the vehicle can be also used instead of the vehicle speed.

As referred to FIG. 4, a differential-torque calculating portion M14 calculates a differential torque by subtracting the road load and the model-error-cancellation amount from the input shaft torque. An inertia calculating portion M15 calculates vehicle inertia using the gear ratio of the gear train 15 as a parameter. A calculating portion M16 calculates delta revolution speed [rad/sec] by dividing the differential torque by the vehicle inertia. Further, a revolution-speed converting portion M17 converts the delta revolution speed [rad/sec] in unit into revolution speed [rpm].

A selecting portion M18 selects one of the actual engine speed and the previous value of the perfect reference speed in accordance with an executing condition of the oscillation reduction control. A calculating portion M19 calculates the perfect reference speed [rpm] by adding the speed [rpm], which is selected using the selecting portion M18, to the revolution speed [rpm].

As shown in FIG. 6, the oscillation control torque calculating unit M2 calculates the oscillation control torque by a feedback control using the engine speed as a parameter. In this example, the oscillation control torque calculating unit M2 adopts a proportional control.

A speed-deviation calculating portion M21 calculates the deviation between the perfect reference speed and the actual engine speed. A high-pass filter portion (HPF) M22 extracts a predetermined high-frequency component from this revolution speed deviation, between the perfect reference speed and the actual engine speed, by subjecting high-pass filtering to the revolution speed deviation. Thus, a steady-state deviation contained in the revolution speed deviation is removed. A gain setting portion M23 calculates a proportional gain (P gain) using the actual engine speed and the gear ratio of the gear train 15 as parameters.

A calculating portion M24 calculates the oscillation control torque by multiplying the P gain by the revolution speed deviation after the high-pass filtering. A limiting portion M25 applies a lower-limit guard based on a lower-limit guard value so as to determine a final oscillation control torque. On this occasion, the lower-limit guard value is, for example, zero, whereby the oscillation control torque is always set at a value greater than zero. Accordingly, as referred to FIG. 3, the corrected shaft torque, which is calculated by subtracting the oscillation control torque from the input shaft torque in the shaft-torque correcting unit M3, is corrected only to a negative side.

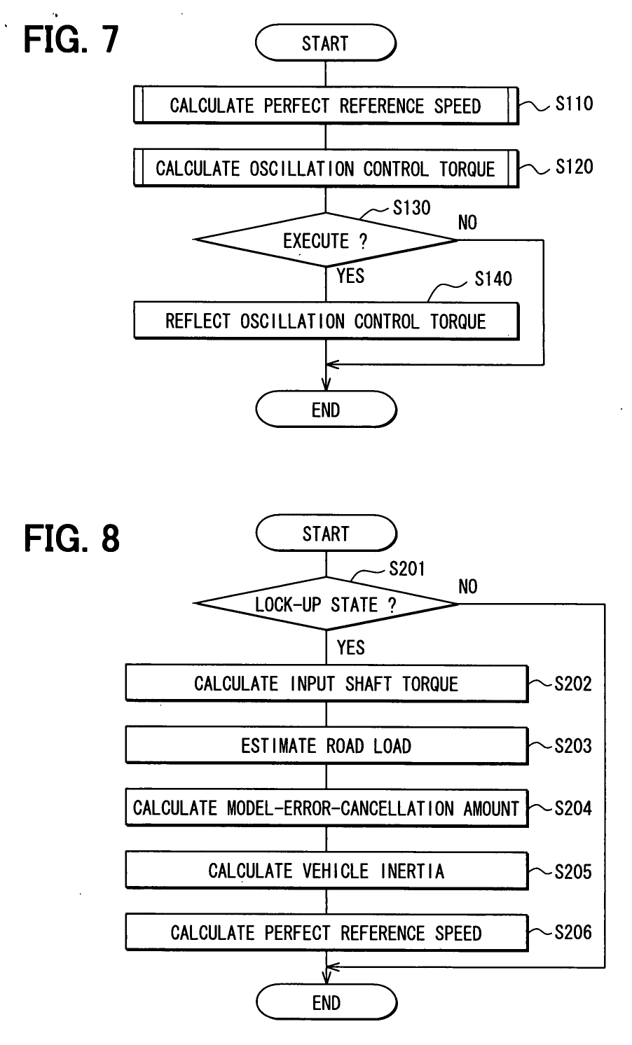

Next, a process of the vehicle oscillation control executed by the ECU 20 is described with reference to FIG. 7. The ECU 20 executes the process shown in FIG. 7 at a predetermined interval.

In step S110, the ECU 20 calculates the perfect reference speed using the perfect reference model. In step S120, the ECU 20 calculates the oscillation control torque in accordance with the revolution speed deviation.

In step S130, the ECU 20 evaluates a control executing condition. When the execution condition is satisfied, the routine proceeds to step S140, in which the ECU 20 calculates the corrected shaft torque so as to reflect the oscillation control torque. After calculating the corrected shaft torque, the ECU 20 executes the torque control of the engine 11 on the basis of this corrected shaft torque. Specifically, the ECU 20 calculates an ignition-timing correction amount on the basis of the corrected shaft torque, so that the ECU 20 corrects an ignition timing toward the advanced side or the retarded side by the ignition-timing correction amount. Thus, the ECU 20 adjusts the output torque of the engine 11.

The control executing condition of step S130 includes the following conditions, such as:

when there is not any request for controlling the ignition timing, such as an ignition retardation control for an quick catalyst warming up;

when time elapsed since starting the engine is equal to or greater than a predetermined time period, and the starting the engine is completed;

when the vehicle speed is equal to or greater than predetermined speed such as 5 km/h;

when oscillation due to torsion of the drive shaft 18 may occur in a condition where, for example, the torque converter 13 is in a lock-up state;

when there is not any vehicle motion control, such as a traction control or a yaw control, for the vehicle 10;

when the vehicle 10 is in a transient mode, in which driver's request torque changes by equal to or greater than a predetermined amount, and in a period, in which the oscillation control torque based on the oscillation reduction control decreases to be equal to or less than a predetermined value, after the transient mode; and

when the oscillation control torque is equal to or greater than a predetermined value during oscillation control.

Next, the calculation of the perfect reference speed performed in a subroutine of step S10 in FIG. 7 is described with reference to FIG. 8.

In step S201, the ECU 20 evaluates whether the torque converter 13 is in a lock-up state, a flex lock-up state, or the like, in which the torque converter 13 transfers torque via, for example, a mechanical transmission, in addition to fluidic transmission. When the torque converter 13 is in the lock-up state, the flex lock-up state, or the like, the processing proceeds to the succeeding step S202. When the torque converter 13 is in a release state, the processing is terminated.

In step S202, the ECU 20 calculates the input shaft torque of the drive train by multiplying the request crankshaft torque by the torque converter gain (Input shaft torque=Request crankshaft torque×Torque converter gain). In step S203, the ECU 20 estimates the road load in accordance with the quadratic formula of the vehicle speed.

In step S204, the ECU 20 calculates the model-error-cancellation amount using Formula (1) mentioned above. In step S205, the ECU 20 calculates the vehicle inertia, which is measured in accordance with the gear position beforehand. In step S206, the ECU 20 calculates the perfect reference speed on the basis of the input shaft torque, the road load, the model-error-cancellation amount, the vehicle inertia, and the like.

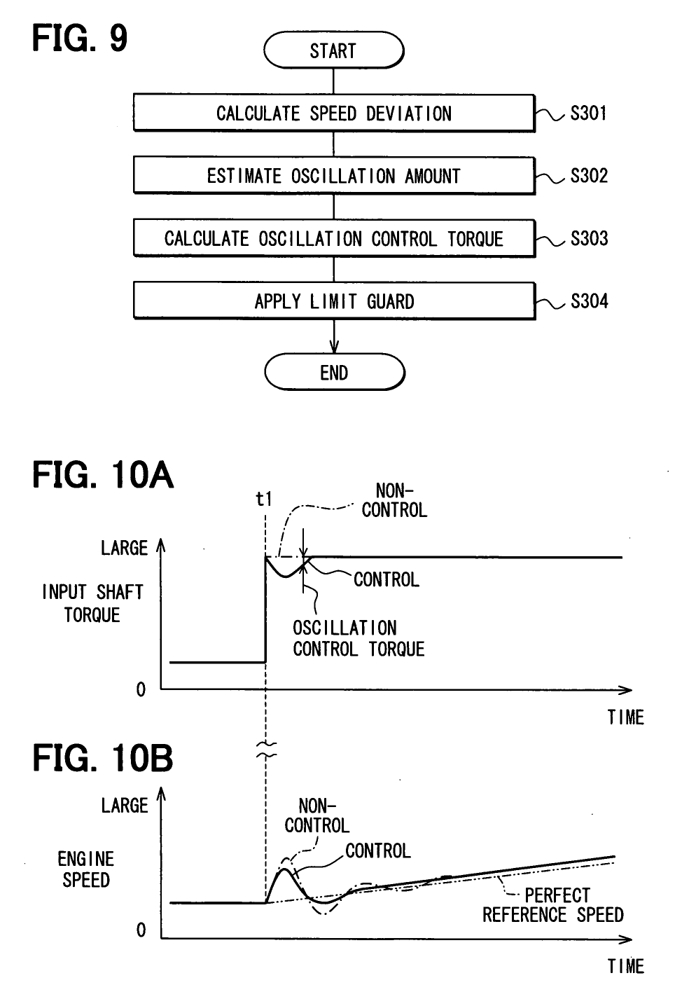

Next, the calculation of the oscillation control torque performed in a subroutine of step S120 in FIG. 7 is described with reference to FIG. 9.

In step S301, the ECU 20 calculates the deviation between the perfect reference speed and the actual engine speed. In step S302, the ECU 20 extracts the predetermined high-frequency component of the revolution speed deviation by subjecting this revolution speed deviation to the high-pass filtering so as to estimate an oscillation amount. In step S303, the ECU 20 calculates the oscillation control torque by multiplying the oscillation reduction gain (P gain) by the oscillation amount, which is the revolution speed deviation extracted in step S302 by the high-pass filtering. In step S304, the ECU 20 applies the lower-limit guard to the oscillation control torque calculated in step S303, so that the ECU 20 obtains the final oscillation control torque.

Next, advantages based on the above oscillation reduction control of the vehicle are described with reference to FIGS. 10A, 10B. In FIGS. 10A, 10B, the solid lines indicate behaviors in the case where the oscillation reduction control of this embodiment is executed, and the dot-and-dash lines indicate behaviors in the case where the oscillation limitation control is not executed. In FIG. 10B, the two-dot chain line indicates the transition of the perfect reference speed.

Now, when the accelerator is manipulated at the timing t1 by the driver, the input shaft torque changes as shown in FIG. 10A. In this condition, when the oscillation reduction control (oscillation control) of this embodiment is not executed as depicted by the dot-and-dash line, the input shaft torque is substantially constant after manipulating the accelerator. At that time, as referred to FIG. 10B, the engine speed greatly oscillates, and consequently, oscillation arises in the vehicle 10. As already stated, the oscillation is caused by the torsion of the drive shaft 18 and the like.

By contrast, in the oscillation reduction control, the ECU 20 calculates the perfect reference speed using the perfect reference model after manipulating the accelerator, so that the ECU 20 calculates the oscillation control torque on the basis of the deviation between the perfect reference speed and the actual engine speed. Therefore, the ECU 20 corrects the input shaft torque using the oscillation control torque, so that the engine speed oscillation becomes smaller than in the case where the control is not executed as indicated by the dot-and-dash line. Thus, the vehicle oscillation can be reduced. In addition, the oscillation control torque is applied with the lower-limit guard as stated before, so that the corrected shaft torque is defined only on the negative side.

Here, in FIG. 10B, a deviation remains between the actual engine speed and the perfect reference speed. The deviation, however, may not affect the function for suppressing oscillation, because the perfect reference speed is used only for the extraction of the oscillation component. In addition, the hi-pass filter reduces a deviation which is small relative to the oscillation and steady-state deviation.

In the torque control for reducing vehicle oscillation, the perfect reference model of the drive train is defined under the assumption that the torsion is not generated in the drive shaft 18 and the like. Therefore, even when the perfect reference model is discrepant from the actual transfer function and the like of the vehicle, such discrepancy may not cause a problem. The control can be restricted from being degraded in accuracy due to difference of the transfer function and the like. A torsion angle and the like need not be detected for observing the actual state of the vehicle. As a result, the vehicle oscillation can be appropriately reduced without complicating the system configuration or degrading the control in accuracy due to components tolerance and the like.

The oscillation control torque is calculated on the basis of the deviation between the actual engine speed and the perfect reference speed, which is calculated using the perfect reference model. The control apparatus accordingly has a preferable construction, which is not provided with additional devices such as sensors for detecting the torsion of the shaft and the oscillation due to the torsion.

The deviation between the actual engine speed and the perfect reference speed, which is calculated using the perfect reference model, is subjected to the high-pass filtering, and the oscillation control torque is calculated on the basis of the revolution speed deviation after being subjected to the high-pass filtering. Therefore, the steady-state deviation of the perfect reference model can be substantially neglected.

The model-error-cancellation amount is calculated using the actual vehicle speed as the parameter, and the perfect reference speed is calculated so as to reflect the model-error-cancellation amount. The derivative value of the perfect reference speed can be maintained within a range, which is equal to or less than a maximum derivative value, and is equal to or greater than a minimum derivative value. The maximum derivative value of the revolution speed is calculated in accordance with the maximum acceleration of the actual vehicle. The minimum derivative value of the revolution speed is calculated in accordance with the minimum acceleration that does not degrade acceleration.

Therefore, even when the vehicle is in a towing condition, or when the vehicle runs on a downhill, and consequently, the operating condition of the vehicle changes, the perfect reference speed may be in the above range defined by the maximum derivative value and the minimum derivative value. Thus, the perfect reference speed can be corrected on the basis of the speed of the actual vehicle.

In the torque control for reducing vehicle oscillation, the input shaft torque is corrected only to the decrease side such that the input shaft torque is reduced. Therefore, unintended acceleration due to unintended rise in torque can be restricted, so that the drivability of the vehicle and the like can be maintained.

In this embodiment, the actual vehicle speed is used as the parameter for calculating the error correction amount of the perfect reference model. The actual vehicle speed can be replaced with the accelerator position or the rate in change of the accelerator position.

In this embodiment, the P control is used for calculating the oscillation control torque in accordance with the revolution speed deviation between the perfect reference speed and the actual engine speed. Alternatively, the P control may be replaced with another feedback control algorithm such as PI control or PID control.

In this embodiment, the lower-limit guard value of the oscillation control torque is set at zero, whereby the oscillation control torque is always set to be greater than zero. Alternatively, this configuration may be modified as appropriate. For example, the lower-limit guard value may be set at a predetermined positive value or set at a predetermined negative value. When the lower-limit guard value is set at the negative value, the oscillation control torque may become a negative value, consequently, input shaft torque may be corrected toward the increase side such that the input shaft torque increases. Therefore, the lower-limit guard value is desirably be set at a value close to zero in order to restrict the torque from abruptly increasing.

In adjusting the engine torque by the ignition timing control of the engine 11, a limit may be set on the advanced side of the ignition. Thus, an unintended acceleration and the like due to abrupt rise in torque can be restricted, so that the drivability of the vehicle can be maintained.

In the spark ignition engine, adjusting the ignition timing is enable to easily reduce the engine power. However, it is hard to increase the engine power for producing desirable engine power depending upon some running conditions. In this respect, the engine power can be uniformly and regularly produced by beforehand limiting the engine power toward the decrease side.

In this embodiment, the spark ignition gasoline engine is used as the power source of the vehicle. Alternatively, another kind of engine such as a diesel engine may be used. An electric motor may be used as the power source. In any cases, the perfect reference model of the vehicle drive train is defined under the assumption that torsion is not generated in the shaft, and the torque control is performed using the perfect reference model. Thus, the vehicle oscillation can be appropriately reduced without complicating the system configuration, or without degrading the accuracy in control due to an components tolerance dispersion or the like.

The above processings such as calculations and determinations are not limited being executed by the ECU 20. The control unit may have various structures including the ECU 20 shown as an example.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An oscillation control apparatus for a vehicle having a drive train for traveling on a road surface, the drive train including a power source for generating torque transmitted to wheels via a shaft, the oscillation control apparatus comprising:
a perfect reference model of the drive train,
wherein the perfect reference model inputs the torque, which is generated using the power source, and road load, which is resistance force applied to the vehicle,
the perfect reference model outputs revolution speed of the power source,
the perfect reference model includes a perfect reference-speed calculating unit for calculating perfect reference speed of the power source under an assumption that the shaft is free from torsion therein, and
the perfect reference model further includes a power controlling unit for controlling the torque on the basis of the perfect reference speed.

2. The oscillation control apparatus according to claim 1,
wherein the power controlling unit calculates a power correction amount, which is required for reducing oscillation in the vehicle, on the basis of deviation between the perfect reference speed and actual revolution speed of the power source, and
the power controlling unit controls the torque on the basis of the power correction amount.

3. The oscillation control apparatus according to claim 2,
wherein the power controlling unit includes a high-pass filter,
the power controlling unit obtains a filtered deviation by passing the deviation between the perfect reference speed and the actual revolution speed through the high-pass filter, and
the power controlling unit calculates the power correction amount on the basis of the filtered deviation.

4. The oscillation control apparatus according to claim 1,
wherein the perfect reference-speed calculating unit includes a unit for calculating an error correction amount of the perfect reference model using actual speed of the vehicle as a parameter, and
the perfect reference-speed calculating unit calculates the perfect reference speed by reflecting the error correction amount.

5. The oscillation control apparatus according to claim 1, wherein the power controlling unit controls the torque by restricting the torque from increasing.

6. The oscillation control apparatus according to claim 1,
wherein the power source is an internal combustion engine that produces engine torque by controlling an ignition timing, and
the power controlling unit restricts the engine torque by limiting the ignition timing on an advanced side of the ignition timing.

7. A method for controlling oscillation of a vehicle having a drive train for traveling on a road surface, the drive train including a power source for generating torque transmitted to wheels via a shaft, the method comprising:
calculating perfect reference speed of the power source on the basis of the torque, which is generated using the power source, and road load, which is resistance force applied to the vehicle, under an assumption that the shaft is free from torsion therein; and
controlling revolution speed of the power source to generate the torque on the basis of the perfect reference speed.
